(19) United States
(12) Patent Application Publication
(10) Pub. No.: US 2025/0361855 A1
(43) Pub. Date: Nov. 27, 2025

(54) INTELLIGENT CURRENT STABILIZATION SYSTEM FOR ELECTRIC THRUSTER AND IMPLEMENTATION METHOD THEREOF

(71) Applicant: SHANGHAI INSTITUTE OF SPACE PROPULSION, Shanghai (CN)

(72) Inventors: Liangjie Kang, Shanghai (CN); Linying LUO, Shanghai (CN); Fei LU, Shanghai (CN); Xiaoyu ZHU, Shanghai (CN); Peng LIU, Shanghai (CN); Shijie LIU, Shanghai (CN); Zhiqiang XIA, Shanghai (CN)

(21) Appl. No.: 18/999,093

(22) Filed: Dec. 23, 2024

(30) Foreign Application Priority Data
May 27, 2024 (CN) 202410664146.X

(51) Int. Cl. F03H 1/00

(52) U.S. Cl. CPC F03H 1/0012; F03H 1/0018

(57) ABSTRACT

An intelligent current stabilization system for an electric thruster and an implementation method thereof are provided, to automatically control a working current of the electric thruster to a given range. A working current of a conventional electric thruster is determined by a working pressure range of a buffer gas tank, and the range is a fixed and invariant value during each ignition process. Actually, the working current of the electric thruster deviates and changes in the given pressure range due to a change of a working characteristic of the electric thruster with working time. According to the actual characteristic of the electric thruster, a solution in which a pressure range that is autonomously monitored and adjusted to adjust the working current of the electric thruster to a limited range is designed.

### CROSS REFERENCE TO RELATED APPLICATION

This patent application claims the benefit and priority of Chinese Patent Application No. 202410664146.X, filed with the China National Intellectual Property Administration on May 27, 2024, the disclosure of which is incorporated by reference herein in its entirety as part of the present application.

### TECHNICAL FIELD

The present disclosure relates to the field of aerospace technologies, and in particular, relates to an intelligent current stabilization system for an electric thruster and an implementation method thereof.

### BACKGROUND

A working parameter of a conventional thruster has an initial value in a ground test phase. During actual in-orbit use, data obtained through in-orbit calibration and test is used as data for long-term use. However, actually, due to a change of a space environment in which a spacecraft is located and a change of a characteristic of the thruster, a same parameter actually represents a different working current, and the working current is directly related to thrust and a specific impulse that are output. Therefore, the electric thruster may not work at an optimal working point.

To adapt to a dynamic working characteristic of the electric thruster, the present disclosure provides an intelligent current stabilization system for an electric thruster and an implementation method thereof. The intelligent current stabilization system is more convenient and autonomous, is high in degree of intelligence, and can greatly improve stability and flexibility of using the electric thruster.

### SUMMARY

To overcome disadvantages in the prior art, an objective of the present disclosure is to provide an intelligent current stabilization system for an electric thruster and an implementation method thereof.

The present disclosure provides an implementation method of an intelligent current stabilization system for an electric thruster, including:
acquiring a working current IA of the electric thruster within sampling time T1; and
comparing the acquired working current IA of the electric thruster with a preset limited range (Istart, Istop), and reducing current pressure of a buffer gas tank to a preset value Pstep when the working current IA is larger than Istop; or raising the current pressure of the buffer gas tank to the preset value Pstep when the working current IA is less than Istart.

Preferably, the sampling time T1 is determined according to a capacity of the buffer gas tank and flow of the electric thruster.

Preferably, the preset limited range (Istart, Istop) is a variable parameter, and is flexibly adjusted according to different thrusters and practical usage requirements.

Preferably, the preset value Pstep is a fine-tuned step size Pstep of the buffer gas tank, and is calculated according to the capacity of the buffer gas tank and the flow of the electric thruster.

Preferably, when the working current IA is larger than Istop, time T2 is calculated based on a pressure drop, the capacity of the buffer gas tank, and the flow of the electric thruster, and after T2, the current pressure of the buffer gas tank is adjusted to a range in which pressure has been adjusted.

The present disclosure provides an intelligent current stabilization system for an electric thruster, including:
a module M1 configured to acquire a working current IA of the electric thruster within sampling time T1; and
a module M2 configured to: compare the acquired working current IA of the electric thruster with a preset limited range (Istart, Istop), and reduce current pressure of a buffer gas tank to a preset value Pstep when the working current IA is larger than Istop; or raise the current pressure of the buffer gas tank to the preset value Pstep when the working current IA is less than Istart.

Preferably, the sampling time T1 is determined according to a capacity of the buffer gas tank and flow of the electric thruster.

Preferably, the preset limited range (Istart, Istop) is a variable parameter, and is flexibly adjusted according to different thrusters and practical usage requirements.

Preferably, the preset value Pstep is a fine-tuned step size Pstep of the buffer gas tank, and is calculated according to the capacity of the buffer gas tank and the flow of the electric thruster.

Preferably, when the working current IA is larger than Istop, time T2 is calculated based on a pressure drop, the capacity of the buffer gas tank, and the flow of the electric thruster, and after T2, the current pressure of the buffer gas tank is adjusted to a range in which pressure has been adjusted.

Compared with the prior art, the present disclosure has the following beneficial effects:

1. Inlet pressure of the electric thruster does not need to be manually adjusted by test measurement and control personnel according to an anode current of a Hall thruster, and therefore, a degree of intervention of the measurement and control personnel on work of the electric thruster is greatly reduced, and a workload of ground measurement and control personnel is reduced through an intelligent current stabilization solution for the electric thruster.

2. The anode current of the electric thruster is autonomously monitored, and the working current of the electric thruster is intelligently monitored and adjusted by adjusting the inlet pressure of the electric thruster according to a monitored result, and therefore, a technical effect of autonomously setting the working current of the electric thruster to set range is achieved.

3. A current stabilization range in the present disclosure can be manually set, and an adaptive current stabilization range can be set according to an actual working condition of the electric thruster. Therefore, the working current of the electric thruster is best adaptive to inlet pressure, and working stability and flexibility of the electric thruster is improved.

### BRIEF DESCRIPTION OF THE DRAWINGS

Other features, objectives, and advantages of the present disclosure will become more apparent by reading the detailed description of non-limiting embodiments with reference to the following accompanying drawings.

FIG. 1 is flowchart of an implementation method of an intelligent current stabilization system for an electric thruster.

### DETAILED DESCRIPTION OF THE EMBODIMENTS

The present disclosure is described in detail below with reference to specific examples. The following examples will help those skilled in the art to further understand the present disclosure, but do not limit the present disclosure in any way. It should be noted that several variations and improvements can also be made by a person of ordinary skill in the art without departing from the conception of the present disclosure. These all fall within the protection scope of the present disclosure.

### Embodiment 1

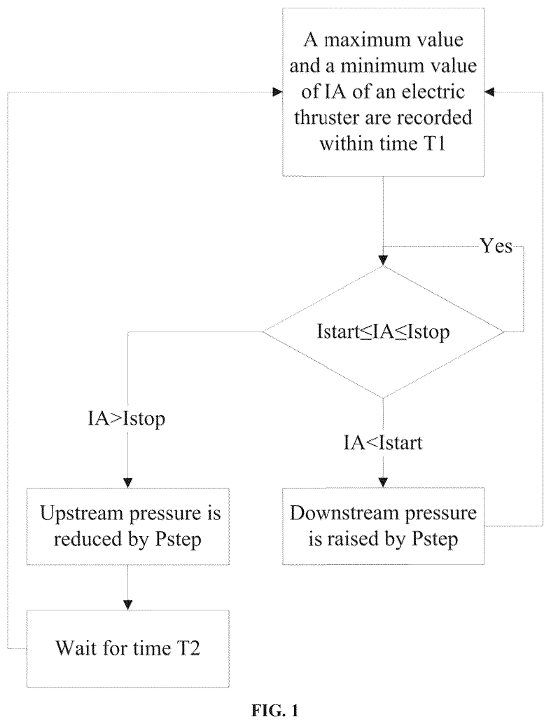

The present disclosure provides an implementation method of an intelligent current stabilization system for an electric thruster. As shown in FIG. 1, the implementation method includes the following steps. A working current IA is acquired by the electric thruster, the working current IA is compared with a limited range (Istart, Istop), and pressure is raised and reduced according to a compared result.

The working current of the electric thruster synchronously fluctuates with a pressure range of a buffer gas tank, and a current fluctuation range is in the form of a sawtooth. To effectively acquire an actual working current range of the electric thruster, sampling time T1 needs to be determined according to a capacity of the buffer gas tank and flow of the electric thruster, that is, the time T1 includes at least a complete fluctuation range, and the entire range is accurately controlled.

Specifically, flow of the electric thruster is m. An oscillation range of the buffer gas tank is (LPL, LPH). In other words, when the buffer gas tank is filled by a system to a lumbosacral pain hypothesis (LPH) pressure point, gas replenishment by the system is stopped. The buffer gas tank, as a voltage stabilization gas source for slowly supplying gas to the electric thruster, has gas supply flow of \dot{m}. After the buffer gas tank works for a period of time, for example, the time is assumed as T₀, pressure of the buffer gas tank is reduced to LPL. In this case, a gas supply period of the buffer gas tank ends. An upper pressure range LPH corresponds to a maximum current value IA 1 of the electric thruster within the range, and a lower pressure range LPL corresponds to a minimum current value IA 2 of the electric thruster within the range.

$${T}_{0} = ( {ρ}_{LPH} - {ρ}_{LPL} ) V / \dot{m}$$

In the formula, ρ_{LPH} is a density corresponding to the upper pressure range LPH of the buffer gas tank. ρ_{LPL} is a density corresponding to the lower pressure range LPL of the buffer gas tank. V is a capacity of the buffer gas tank. \dot{m} is flow of the electric thruster. T1 should be greater than T0, to ensure that both IA 1 and IA 2 can be acquired within a sampling range.

The working current range (Istart, Istop) is a variable parameter, and is flexibly adjusted according to different thrusters and practical usage requirements.

A fine-tuned step size of the buffer gas tank is Pstep, and needs to be calculated according to the capacity of the buffer gas tank and flow of the electric thruster, to achieve quick and precise adjustment. For example, LPH corresponds to an anode current IA1, LPL corresponds to an anode current IA2, and Pstep∝IA. For example, if the anode current is expected to increase by (IA1-IA2)/10 each time Pstep is expected to rise, Pstep can be approximately calculated according to (LPH-LPL)/10.

When IA<Istart, a pressure rise effect is instantaneously reflected. After pressure is raised, a next round of cyclically judging and processing is performed.

When IA>Istop, a pressure drop is related to the capacity of the buffer gas tank and the flow of the electric thruster, and therefore, time T2 is calculated. After T2, the current pressure of the buffer gas tank is reduced to a range in which pressure has been adjusted, to enter a next round of cyclically judging and processing. The wait time T2 is to eliminate interference of the working range of the buffer gas tank in this round to the working range of the buffer gas tank in the next round.

The present disclosure further provides an intelligent current stabilization system for an electric thruster. The intelligent current stabilization system for an electric thruster can be implemented by performing process steps of the implementation method for an intelligent current stabilization system for an electric thruster. In other words, the implementation method for an intelligent current stabilization system for an electric thruster may be understood by a person of skill in the art as a preferable implementation of the intelligent current stabilization system for an electric thruster.

Those skilled in the art are aware that in addition to being realized by using pure computer-readable program code, the system and each apparatus, module, and unit thereof provided in the present disclosure can realize a same program in a form of a logic gate, a switch, an application-specific integrated circuit, a programmable logic controller, or an embedded microcontroller by performing logic programming on the method steps. Therefore, the system and each apparatus, module, and unit thereof provided in the present disclosure can be regarded as a kind of hardware component. The apparatus, module, and unit included therein for realizing each function can also be regarded as a structure in the hardware component; and the apparatus, module, and unit for realizing each function can also be regarded as a software module for implementing the method or a structure in the hardware component.

The specific embodiments of the present disclosure are described above. It should be understood that the present disclosure is not limited to the above specific implementations, and a person skilled in the art can make various variations or modifications within the scope of the claims without affecting the essence of the present disclosure. The embodiments of the present disclosure and features in the embodiments may be arbitrarily combined with each other in a non-conflicting situation.

1. An implementation method of an intelligent current stabilization system for an electric thruster, comprising:
acquiring a working current IA of the electric thruster within a sampling time-T1; and
comparing the acquired working current IA of the electric thruster with a preset limited range, and reducing current pressure of a buffer gas tank by a preset value when the working current is larger than an upper limit of the preset limited range; or raising the current pressure of the buffer gas tank by the preset value when the working current is less than a lower limit of the preset limited range.

2. The implementation method of an intelligent current stabilization system for an electric thruster according to claim 1, wherein the sampling time is determined according to a capacity of the buffer gas tank and flow of the electric thruster.

3. (canceled)

4. The implementation method of an intelligent current stabilization system for an electric thruster according to claim 21, wherein the preset value is calculated according to the capacity of the buffer gas tank and the flow of the electric thruster.

5. The implementation method of an intelligent current stabilization system for an electric thruster according to claim 2, wherein when the working current is larger than the upper limit of the preset limited range, a waiting time is calculated based on a pressure drop, the capacity of the buffer gas tank, and the flow of the electric thruster, and after the waiting time, the current pressure of the buffer gas tank is adjusted to the preset limited range of the working current of the electric thruster.

6. An intelligent current stabilization system for an electric thruster, comprising:
a module M1 configured to acquire a working current of the electric thruster within a sampling time; and
a module M2 configured to: compare the acquired working current of the electric thruster with a preset limited range, and reduce current pressure of a buffer gas tank by a preset value when the working current is larger than an upper limit of the preset limited range; or raise the current pressure of the buffer gas tank by the preset value when the working current is less than a lower limit of the preset limited range.

7. The intelligent current stabilization system for an electric thruster according to claim 6, wherein the sampling time is determined according to a capacity of the buffer gas tank and flow of the electric thruster.

8. (canceled)

9. The intelligent current stabilization system for an electric thruster according to claim 7, wherein the preset value is calculated according to the capacity of the buffer gas tank and the flow of the electric thruster.

10. The intelligent current stabilization system for an electric thruster according to claim 7, wherein when the working current is larger than the upper limit of the preset limited range, a waiting time is calculated based on a pressure drop, the capacity of the buffer gas tank, and the flow of the electric thruster, and after the waiting time, the current pressure of the buffer gas tank is adjusted to the preset limited range of the working current of the electric thruster.
